(19) United States
(12) Patent Application Publication
(10) Pub. No.: US 2005/0075958 A1
(43) Pub. Date: Apr. 7, 2005

(54) Cellular phone financial device

(76) Inventor: Edwin Gonzalez, Lighthouse Point, FL (US)

Correspondence Address: Ruben Alcoba, 17347 SW 20th CT, Miramar, FL, 33029, US

(21) Appl. No.: 10/676,468

(22) Filed: Oct. 1, 2003

(51) Int. Cl. G06F 17/60

(52) U.S. Cl. 705/35; 705/43

(57) ABSTRACT

A cellular phone financial device that protects user's financial accounts from being compromised by third parties comprises a cellular phone having an alias software that encrypts and decrypts financial requests sent over the cellular airwaves by the cellular phone, a server that communicates with the cellular phone, wherein the server has an alias software program that encrypts and decrypts requests sent and received from the cellular phone and further translates the financial accounts of the user to alias when communicating with the cellular phone, a database that stores the financial accounts of the user that is accessed by the server when translating the aliases of the user to actual account numbers, a processor that receives and processes requests from the server, wherein requests are instructions to perform certain financial transactions with the user's accounts, and financial institutions that process the information requested by the processor and return confirmation to the processor of the performance of the request, the processor in turn sends the information received from the financial institutions to the server, and lastly the server translates the user's account number to an alias and sends the information requested to the cellular phone, thereby confirming the performance of the financial transaction to the user.

### BACKGROUND

Today's technology ridden world demands a means for monitoring and undertaking financial transactions over cellular phones. This invention allows users to accomplish the above needs while protecting their financial accounts from being compromised by third parties.

The internet has allowed users to access their business accounts over the internet in a secure manner. This invention is a method of extending the web technology into other fields that do not require the user to be at the enslavement of a physical computer.

It is understood, that the web based applications can be downloaded to cellular phones so that account balances can be monitored. The major problem with these types of transactions over the cellular air waves is that if a user's cell phone account is compromised, in any manner, the user will have allowed third parties to access his accounts. Once an account is compromised, the user's accounts are effectively turned into the accounts of the compromiser.

For this reason there is a need for providing cellular phone users with a cellular phone method and device that protects a user's financial accounts from third parties. This invention allows users to check their accounts over a cell phone, without the dangers of the accounts being compromised. In addition, the cellular phone's security feature allows users to use their cell phones as an engine for finalizing financial transactions, e.g. transferring funds from one account to another without third parties identifying the accounts from where monies are being transferred from or sent to.

An object of this invention is to provide users with a means to check their financial accounts over a cellular phone without the danger of having their accounts compromised by third parties.

Another object of this invention is to allow users the freedom of not needing a computer for checking their financial accounts.

Another object of this invention is to allow users the capacity to instantly finalize transactions at points of sales via a cellular phone, when the point of sale account is known.

### SUMMARY

There is a need for a cellular phone financial device and method of use that will prevent third parties from deciphering financial transactions being sent over the cellular airwaves. The cellular phone financial device that protects user's financial accounts from being compromised by third parties comprises a cellular phone having an alias software that encrypts and decrypts financial requests sent over the cellular airwaves by the cellular phone, a server that communicates with the cellular phone, wherein the server has an alias software program that encrypts and decrypts requests sent and received from the cellular phone and further translates the financial accounts of the user to alias when communicating with the cellular phone, a database that stores the financial accounts of the user that is accessed by the server when translating the aliases of the user to actual account numbers, a processor that receives and processes requests from the server, wherein requests are instructions to perform certain financial transactions with the user's accounts, and financial institutions that process the information requested by the processor and return confirmation to the processor of the performance of the request, the processor in turn sends the information received from the financial institutions to the server, and lastly the server translates the user's account number to an alias and sends the information requested to the cellular phone, thereby confirming the performance of the financial transaction to the user.

Before explaining the invention in detail, it is to be understood that the invention is not limited in its application to the details of construction and to the arrangements of the component set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### DRAWINGS

These and other features, aspects, and advantages of the present invention will become better understood with regard to the following description, appended claims, and drawings where:

FIG. 1 shows a flow chart of the cellular phone financial device;

FIG. 2 shows a flow chart showing the initial downloading and installation of the financial program of the cellular phone financial device;

FIG. 3 shows a flow chart showing the security procedures of the cellular phone financial device;

FIG. 4 shows a flow chart showing how the server initially checks the user's information, and then confirms information to determine continued access to server;

FIG. 5 shows a flow chart showing how the server initially sets up JAD files that will correspond to users accounts, the JAD files will correspond to the users identity and his account numbers and corresponding aliases; and

FIG. 6 shows a flow chart showing an example of how a balance transaction would be carried out using the cellular phone financial device.

### DESCRIPTION

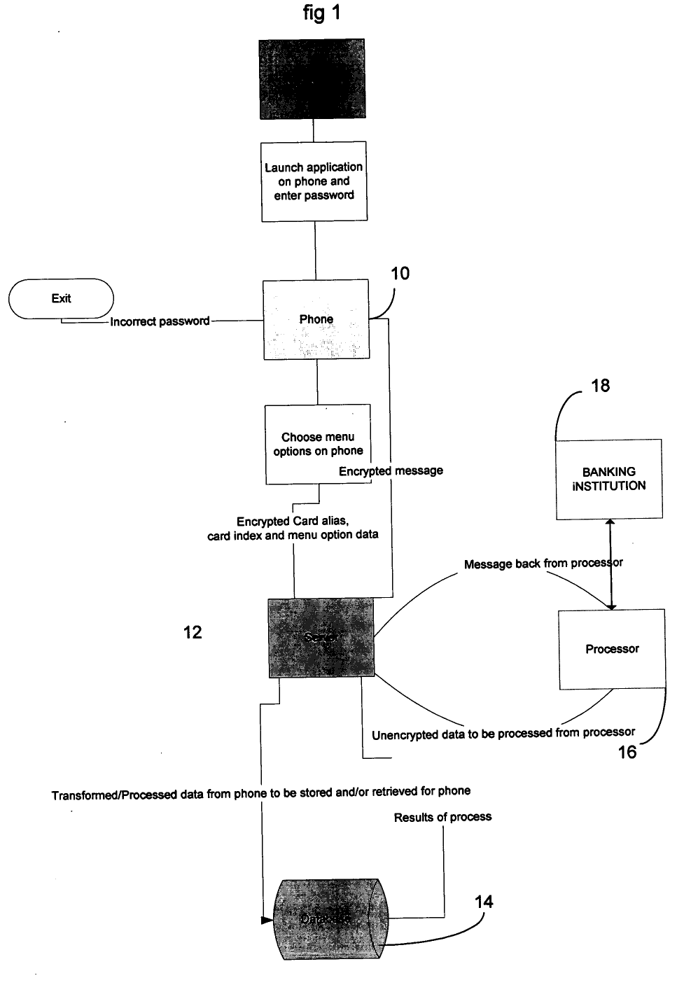

As seen in the flow chart of FIG. 1, a cellular phone financial device that protects user's financial accounts from being compromised by third parties comprises a cellular phone 10 having an alias software that encrypts and decrypts financial requests sent over the cellular airwaves by the cellular phone 10, a server 12 that communicates with the cellular phone 10, wherein the server 12 has an alias software program that encrypts and decrypts requests sent and received from the cellular phone 10 and further translates the financial accounts of the user to alias when communicating with the cellular phone 10, a database 14 that stores the financial accounts of the user that is accessed by the server 12 when translating the aliases of the user to actual account numbers, a processor 16 that receives and processes requests from the server 12, wherein requests are instructions to perform certain financial transactions with the user's accounts, and financial institutions 18 that process the information requested by the processor 16 and return confirmation to the processor 16 of the performance of the request, the processor 16 in turn sends the information received from the financial institutions 18 to the server 12, and lastly, the server 12 translates the user's account number to an alias and sends the information requested to the cellular phone 10, thereby confirming the performance of the financial transaction to the user.

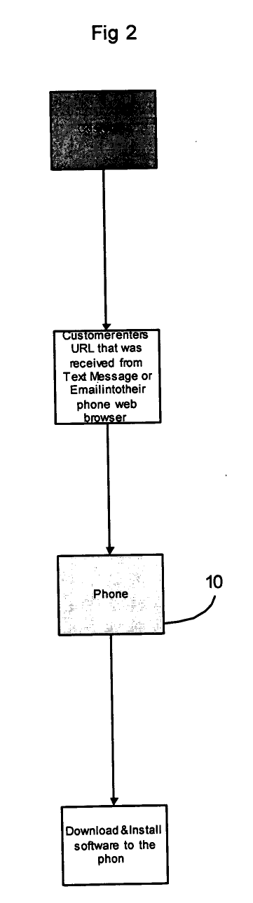

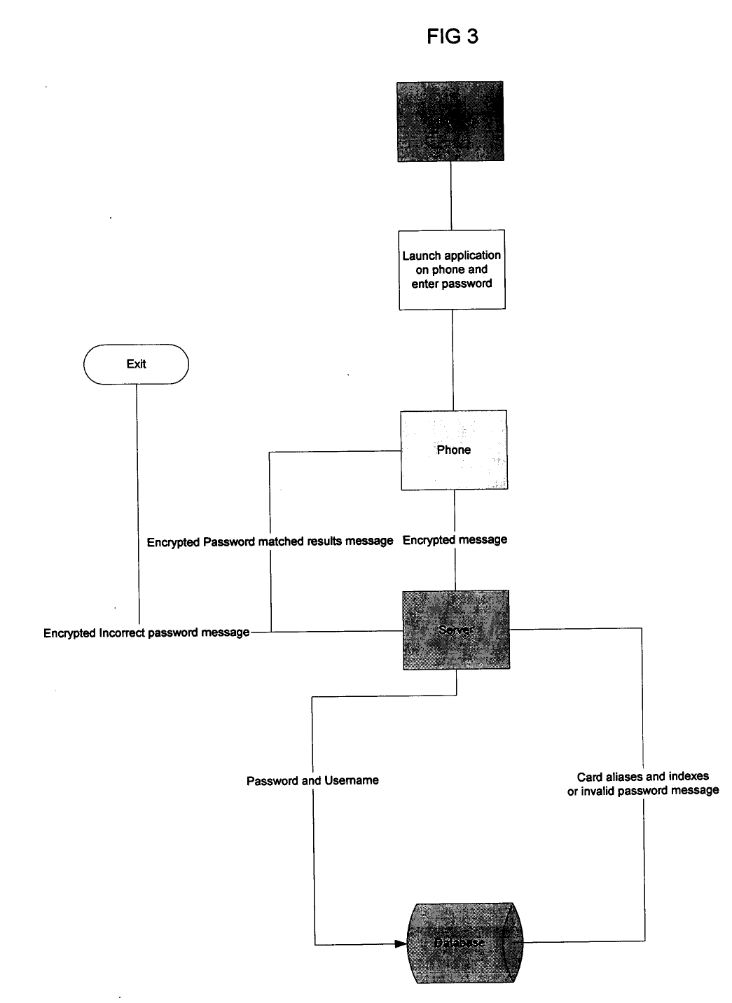

As seen in the flow chart of FIG. 2, the cellular phone 10 is used to communicate with the server 12. The phone 10 is initially downloaded with a cellular financial application that corresponds to the phone 10 that allows access to the server 12. The program downloaded only allows access to the server 12 based on pre-programmed accounts of the user. The cellular application is downloaded from a URL, the application allows the cell phone 10 to encrypt and decrypt messages being sent between the phone 10 and the server 12. The phone 10 displays the accounts being accessed only through aliases. Never will the phone 10 display an account number. As seen in the flow chart of FIG. 3, prior to accessing the user's financial accounts over the phone, the user will have to insert a numerical code that is checked by the server for authenticity.

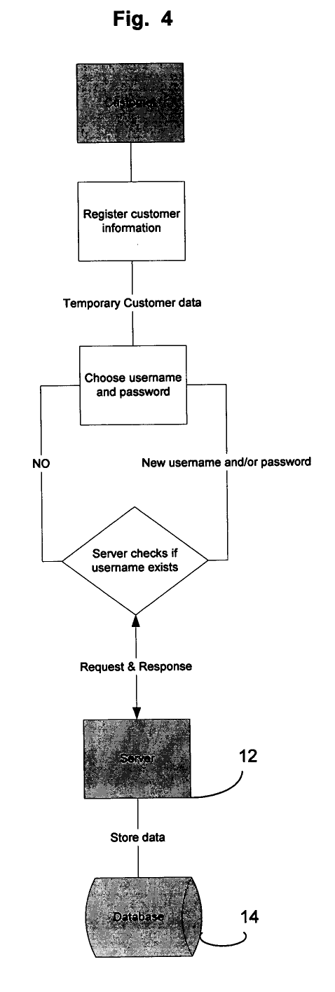

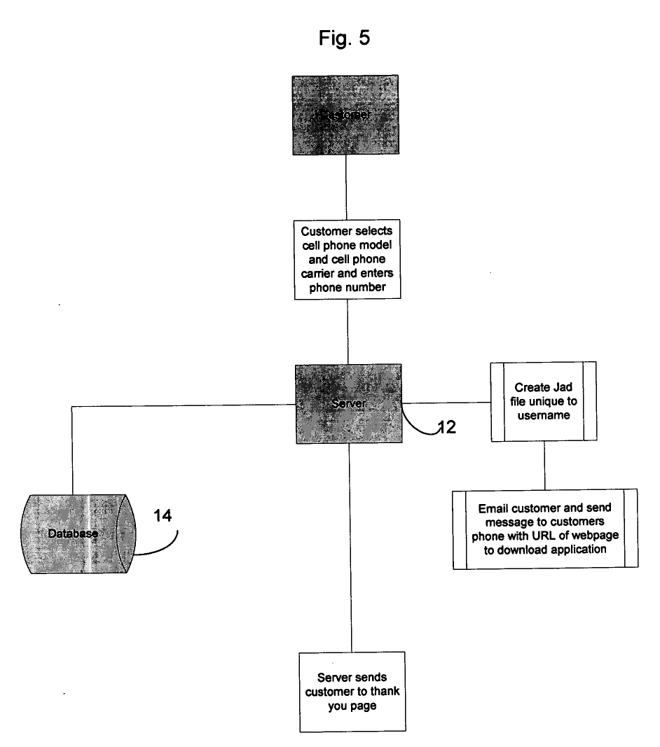

The server communicates with the cellular phone, a database, and a processor. In the flow chart of FIG. 4, the user of this invention initially opens an account with the server 12. When the user initially opens an account with the server 12, the user gives the server 12 all the information regarding the financial accounts he wants to access over the cellular phone 10 and creates corresponding aliases for the accounts. This information is then stored in a database 14 that stores information for the server 12. The server 12 gives the user a specific file that corresponds to his identity. As seen in the flow chart of FIG. 5, the server creates JAD files that correspond to the aliases created by the user, e.g., BOB would correspond to account No. 00001. The user then provides the server 12 with a numerical code that corresponds to his identity/file/JAD file, this information allows the user access to his account over the cellular airwaves.

As further seen in FIG. 2, the user is further given a URL to access via the user's cellular phone 10. Upon user accessing the URL, the URL informs the user to identify himself and to download a financial program that is compatible with his cellular phone 10. Upon the financial program being downloaded and installed, the user then controls all correspondence with the server 12 over the cellular airwaves. As a security precaution, the user is always prompted to enter his numerical code prior to being granted access to the server, as seen in FIG. 3. All transactions sent between the phone 10 and the server 12 are encrypted, both the server 12 and the phone 10 have decryption modules within their programs. The key to this invention is that the server 12 and cellular phone 10 only transmit aliases that correspond to financial accounts stored within the database 14 along with the information requested. Should a third party compromise the secured connection between the server 12 and the phone 10, the secured party would only see an alias that corresponds to an account number and the information requested. The server 12 is programmed to only send the information requested, it does not send information not requested, e.g. account numbers would never be transmitted over the airwaves. As another security feature, a user's identity cannot be modified over the cellular airwave.

The database 14 communicates with the server 12. When the user initially sets up or updates the account, the server 12 sends the user's information to the database 14 for storage and retrieval. The database 14 stores the aliases of the user and the corresponding indexes of the user. The aliases correspond to the user's account numbers, these numbers are accessed by the server when requesting the user's financial information from the processor 16.

The server 12 communicates with the processor 16 after requesting information from the database 14. The server 12 requests user's financial account information from the processor 16 or the server 12 requests the processor 16 to perform a financial transaction. The processor 16 in turn communicates a request to user's financial institution 18. The financial institution 18 then performs user's request. All the information requested is then transmitted from the financial institution 18 back to the processor 16 and then to the server 12. The server 12 then transmits the information requested to the cellular phone 10. The information is sent using aliases, and only the information requested is transmitted to the cellular phone 10.

The server 12 performs all functions regarding the translation of aliases to financial account numbers. The server 12 also performs the function of sending only the information requested to the cellular phone 10, e.g., the user of the cellular phone 10 requests an account balance for alias BOB from the server 12, the server 12 accesses the database 14 for BOB and gets the account information, the server 12 then sends the account information to the processor 16 along with the command that the phone application has requested, then the processor 16 relays the request to the financial institution 18, the financial institution 18 performs the request and relays confirmation of performance of the request to the server 12 via the processor 16, lastly, the server 12 converts the user's financial account back to the alias and relays the information requested to the cellular phone 10.

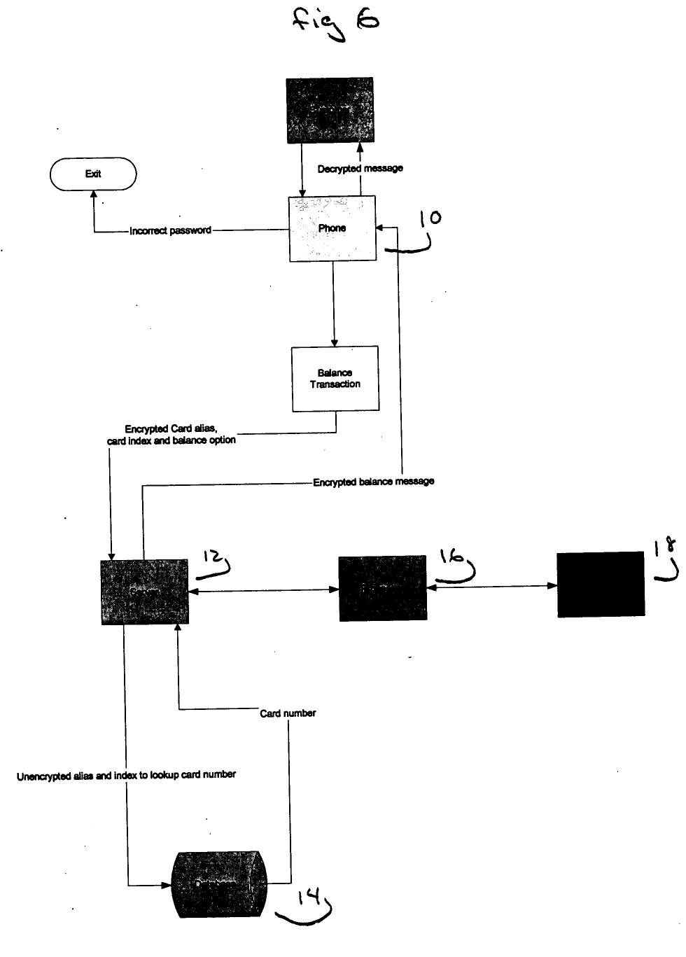

As seen in the flow chart of FIG. 6, the method of use of the cellular phone financial device described above comprises the steps of first, initializing a financial software program within the cellular phone 10, then, sending a request to perform a financial transaction from the user's cellular phone 10 to the server 12 concerning an alias account, converting the alias to an account number within the server 12 using the database 14 to access the actual account number corresponding to the user's alias, next, sending a request from the server 12 to the processor 16 to perform the request requested by the user, then, relaying the request from the processor 16 to the financial institutions 18, confirming the results of the request from the financial institution 18 to the processor 16, relaying the confirmation from the processor 16 to the server 12, and lastly, translating the account information back to the alias and sending the information requested to the user of the cellular phone 10. FIG. 6, shows a specific example in which an account balance is being requested over the cellular phone financial device.

The user can make requests over the cellular phone 10 to check on his financial accounts balances, he can transfer finds from one account to another, and any other functions being able to be carried out via the internet.

An advantage of this invention is that it provides users with a means to check their financial accounts over a cellular phone without the danger of having their accounts compromised by third parties.

Another advantage of this invention is that it allows users the freedom of not needing a computer for checking their financial accounts.

Another advantage of this invention is that it allows users to instantly finalize transactions at points of sales via a cellular phone, when the point of sale account is known.

With respect to the above description then, it is to be realized that the optimum dimensional relationships for the parts of the invention, to include variations in size, material, shape, form, function and manner of operation, assembly and use, are deemed readily apparent and obvious to one skilled in the art, and all equivalent relationships with those illustrated in the drawings and described in the specifications are intended to be encompassed by the present invention.

Therefore, the forgoing description is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. a cellular phone financial device that protects a user's financial accounts from being compromised by third parties comprises:
a cellular phone having an alias software that encrypts and decrypts financial requests sent over the cellular airwaves by the cellular phone;
a server that communicates with the cellular phone, wherein the server has an alias software program that encrypts and decrypts requests sent and received from the cellular phone and further translates the financial accounts of the user to alias when communicating with the cellular phone;
a database that stores the financial accounts of the user that is accessed by the server when translating the aliases of the user to actual account numbers;
a processor that receives and processes requests from the server, wherein requests are instruction to perform certain financial transactions with the user's accounts; and
financial institutions that process the information requested by the processor and return confirmation to the processor of the performance of the request, the processor in turn sends the information received from the financial institutions to the server, and lastly the server translates the user's account number to an alias and sends the information requested to the cellular phone, thereby confirming the performance of the financial transaction to the user.

2. The cellular phone device of claim 1, wherein the request being processed is an account balance.

3. The cellular phone device of claim 1, wherein the request being processed is a transfer of funds from one account to another.

4. A method of using the device of claim 1, comprising the steps of:
first, initializing a financial software program within the cellular phone;
then, sending a request to perform a financial transaction from the user's cellular phone to the server concerning an alias account, converting the alias to an account number within the server using the database to access the actual account number corresponding to the user's alias;
next, sending a request from the server to the processor to perform the request requested by the user;
then, relaying the request from the processor to the financial institutions;
confirming the results of the request from the financial institution to the processor;
relaying the confirmation from the processor to the server; and
lastly, translating the account information back to the alias and sending the information requested to the user of the cellular phone.
